(19) United States
(12) Patent Application Publication
(10) Pub. No.: US 2004/0048146 A1
(43) Pub. Date: Mar. 11, 2004

(54) Electrochemical cells and systems

(76) Inventors: David Adamson, Danbury, CT (US); Boris Makovetski, Danbury, CT (US); David L. Pappas, Danbury, CT (US); Robert Pavlinsky, Stratford, CT (US); Michael J. Zuraw, Bethel, CT (US)

Correspondence Address: FISH & RICHARDSON PC, 225 FRANKLIN ST, BOSTON, MA, 02110, US

(21) Appl. No.: 10/236,106

(22) Filed: Sep. 6, 2002

(51) Int. Cl. H01M 2/12; H01M 12/06

(52) U.S. Cl. 429/83; 429/27; 429/23; 429/61; 429/176; 429/71; 429/50

(57) ABSTRACT

Electrochemical cells and electrochemical cell systems are disclosed.

### TECHNICAL FIELD

The invention relates to electrochemical cells and systems.

### BACKGROUND

Electrochemical cells are commonly used electrical power sources. A cell typically contains a negative electrode, a positive electrode, and an electrolyte. The negative electrode includes an active material that can be oxidized; the positive electrode contains or consumes an active material that can be reduced. The negative electrode active material is capable of reducing the positive electrode active material. In some embodiments, to prevent direct reaction of the positive electrode material and the negative electrode material, the negative electrode and the positive electrode are electrically isolated from each other by a separator.

When a cell is used as an electrical energy source in a device, electrical contact is made to the negative electrode (anode) and the positive electrode (cathode), allowing electrons to flow through the device and permitting the respective oxidation and reduction reactions to occur to provide electrical power. The electrolyte, for example, potassium hydroxide, in contact with the anode and the cathode contains ions that flow through the separator between the electrodes to complete circuit and maintain charge balance throughout the cell during discharge.

In a metal-air electrochemical cell, the positive electrode active material is oxygen, which is supplied to the cathode from the atmospheric air external to the cell through one or more air hole(s) in the cell can. Oxygen is reduced at the cathode and a metal is oxidized at the anode.

In a metal-air electrochemical cell, such as a zinc-air cell, high energy density can be achieved because the cathode active material is not stored within the cell. However, this energy density can be decreased when the cell is open to the air because of carbonation of the electrolyte from atmospheric CO2 and water vapor ingress or egress. To prolong battery life, it is desirable that the cathode be isolated from the air when not in use (e.g., to reduce carbonation), but exposed to the air when in use. During use, it is desirable to provide uniform and sufficient air access to the cathode to provide, for example, uniform discharge of the active materials and/or a relatively high and steady running voltage. Systems, sometimes called air managers, can be used to provide air to the metal-air cell(s) when the cell(s) are needed, and to reduce exposure of the cell(s) to the environment (the air) when there is no load on the cell(s).

### SUMMARY

The invention relates to electrochemical cells and systems, such as, for example, those having metal-air cells.

When used in a device, the systems provide good air management according to the power requirements of the device. Generally, the system exposes cell(s) in the system to air when the device is on, and limits air flow to the cell(s) when the device is off, thereby prolonging the life of the cell(s).

In one aspect, the invention features an electrochemical cell system including a cartridge having an air inlet channel and an air outlet channel, wherein during use air flows through the inlet channel in a substantially opposite direction than air flowing through the outlet channel, an air mover in the cartridge configured to move air through the channels, and a control circuit in the cartridge configured to control operation of the air mover.

Embodiments may include one or more of the following features. The air inlet channel includes an air inlet and the air outlet channel having an air outlet, and the air inlet and outlet are located at the same end of the cartridge. The inlet channel and the outlet channel are located on opposing sides of the cartridge. The air outlet channel extends substantially an entire length of the cartridge. The air outlet channel has a differential cross sectional area along its length. The air mover includes an impeller and a motor. The control circuit activates the air mover at a selected threshold current.

The system may include one or more metal-air cells in the cartridge. The metal-air cell may include a polymeric layer or air membrane, e.g., one including polytetrafluoroethylene, polypropylene, and/or Mylar®, surrounding a portion of the cell and defining an exterior portion of the cell. During use, air can first contact the polymeric layer of the metal-air cell at a portion between the ends of the cell.

The cartridge can be sized to fit into a battery compartment of an electronic device. The battery compartment can be sized to accommodate a plurality of batteries or cartridges. The cartridge may include a housing, and during use, air can be introduced into the housing between the ends of the housing. The cartridge may include a housing, and a portion of the outlet channel that is external to the housing.

In another aspect, the invention features an electrochemical cell system including a cartridge having a first end and an opposing second end, the cartridge further including an air inlet and an air outlet located at the same end, and an air mover in the cartridge, the air mover configured to move air from the inlet to the outlet.

Embodiments may include one or more of the following features. The cartridge includes a channel including the air outlet, the channel extending along substantially an entire length of the cartridge. The cartridge includes a housing, and a portion of the channel is external to the housing. The cartridge has a housing, and the air inlet and outlet are external to the housing. The air mover includes a fan (motor and impeller). The system has a control circuit in the cartridge configured to control operation of the air mover. The system includes one or more metal-air cells in the cartridge. The cartridge is sized to fit into a battery compartment of an electronic device. The battery compartment is sized to accommodate a plurality of batteries or cartridges.

In another aspect, the invention features an electrochemical cell system including a cartridge having an internal volume, and two metal-air cells removably placed in the cartridge, wherein the cells occupy at least 50% of the internal volume of the cartridge. The cells can occupy at least 60% of the internal volume of the cartridge.

In another aspect, the invention features an electrochemical cell system including a cartridge having an internal volume, an air mover in the cartridge, and a control circuit in the cartridge, wherein the air mover and the control circuit occupy less than about 2% of the internal volume of the cartridge. The air mover and the control circuit can occupy less than about 1.6% of the internal volume of the cartridge.

In another aspect, the invention features an electrochemical cell system including a cartridge, and two metal-air cells removably placed in the cartridge, wherein the system has an energy density greater than about 400 Wh/L. The system can have an energy density greater than about 420 Wh/L.

In another aspect, the invention features an electrochemical cell system including a cartridge, and two metal-air cells removably placed in the cartridge, wherein the system has a capacity greater than about 5.4 Ah/cell, e.g., greater than about 5.6 Ah/cell or about 5.8 Ah/cell.

In another aspect, the invention features a metal-air cell including an anode, a polymer layer having openings through the polymer layer, a separator between the anode and the polymer layer, and a cathode between the separator and the polymer layer. The polymer layer is a mesh and/or a resilient tubular sleeve.

In another aspect, the invention features a metal-air cell including an anode, an outer layer having interlocking opposing edges, a separator between the anode and the outer layer, and a cathode between the separator and the outer layer.

Embodiments may include one or more of the following. One edge of the outer layer is configured as dovetails. The outer layer includes a metal. The outer layer includes a polymer. The outer layer includes an air access opening and/or a slit.

In another aspect, the invention features a metal-air cell including a cathode current collector, and a cathode terminal having an integral portion extending radially from the terminal, the integral portion being attached to the cathode current collector.

Embodiments may include one or more of the following. The cathode terminal includes a plurality of discrete, integral portions extending radially from the terminal, the plurality of integral portions being attached to the cathode current collector. The plurality of integral portions are equally spaced about the cathode terminal. The current collector is welded to the integral portion. The cell further includes a polymer seal surrounding a portion of the cathode terminal.

In another aspect, the invention features a method of operating an electrochemical cell system. The method includes introducing air through an air inlet channel of a cartridge in a first direction, and introducing air through an air outlet channel of the cartridge in a second direction opposite to the first direction, wherein air is introduced through the channels by an air mover in the cartridge.

Embodiments may include one or more of the following. The method further includes contacting a metal-air cell in the cartridge with air at a portion between the ends of the cell. The method further includes replacing the metal-air cell with a second metal-air cell. The method further includes activating the air mover according to a preselected threshold current.

In yet another aspect, the invention features a method of operating an electrochemical cell system including providing a cartridge comprising an air inlet and an air outlet located at one end of the cartridge, introducing air into the air inlet, and flowing air through the air outlet and out the cartridge, wherein air is introduced through the air inlet by an air mover in the cartridge.

Embodiments may include one or more of the following. The method further includes contacting a metal-air cell in the cartridge with air at a portion between the ends of the cell. The method further includes replacing the metal-air cell with a second metal-air cell.

Embodiments may have one or more of the following advantages. The system provides a simple and functional system for managing air flow into a metal-air battery. The system can be formed in a variety of shapes to suit different devices, and the system can be produced at a low cost. Operation of the system is simple. In some embodiments, operation of the system is transparent to the user.

Other aspects, features, and advantages of the invention will be apparent from the description of the preferred embodiments thereof and from the claims.

### DESCRIPTION OF DRAWINGS

FIG. 1 is a top perspective view of an embodiment of a cell cartridge.

FIG. 2 is a bottom perspective view of the cell cartridge of FIG. 1.

FIG. 3 is a perspective view of embodiments of metal-air cells and the cell cartridge of FIG. 1.

FIG. 4 is a partially exploded perspective view of the embodiments of FIG. 3.

FIG. 5 is a circuit diagram.

FIGS. 6 and 7 are perspective views of an embodiment of an end cap.

FIG. 8 is a perspective view of an embodiment of a contact end assembly.

FIG. 9 is a cross sectional view of the cell cartridge of FIG. 1.

FIGS. 10, 11, 12, 12A, 12B, and 13 show an embodiment of a metal-air cell and a method of making the cell.

FIGS. 14, 14A, 14B, 14C, 15, 15A, and 15B show an embodiment of a metal-air cell.

FIG. 16 is a schematic view of an embodiment of a cell and a cartridge.

FIG. 17 is a schematic view of an embodiment of a cell system.

FIGS. 18, 19, 20, 21, and 22 are perspective, partially exploded views of an embodiment of a cell cartridge.

FIGS. 23 and 23A show an embodiment of a metal-air cell.

FIGS. 24A, 24B, 24C, 24D, and 24E show an outer layer of a metal-air cell.

FIGS. 25A, 25B, and 25C show an example of a cell system including exemplary dimensions.

### DETAILED DESCRIPTION

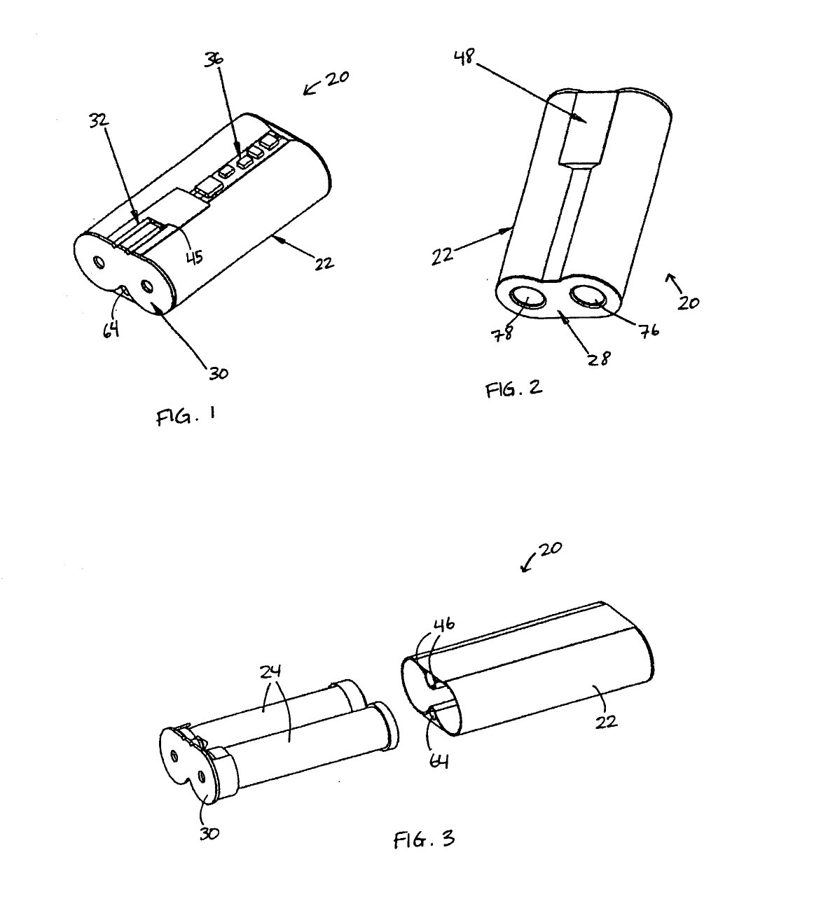

Referring to FIGS. 1-4, an electrochemical cell system 20 includes a re-useable cartridge 22 and one or more replaceable metal-air cells 24 (here, two) that can be placed in the cartridge. Cartridge 22 is designed to provide cells 24 with uniform and sufficient air flow during use. When not in use, the cartridge reduces exposure of the cells to air, thereby extending the life of the cells.

Cartridge 22 is generally sized and configured to fit into a battery compartment of an electronic device. Examples of devices include a camera, a camcorder, a cellular telephone, a toy, a CD player, or a flashlight. Cartridge 22 includes a housing 26 sized and configured to receive one or more cells 24. Housing 26 can be, for example, made of a metal or a plastic, e.g., by molding or extrusion. As shown, housing 26 has a configuration sized to receive, e.g., slidably, two cylindrical cells 24 placed side-by-side. The configuration defines two nooks 56 and 58 on the sides of housing 26. Nook 56 includes a cutaway portion 60, and nook 58 includes a cutaway portion 62 (FIG. 9).

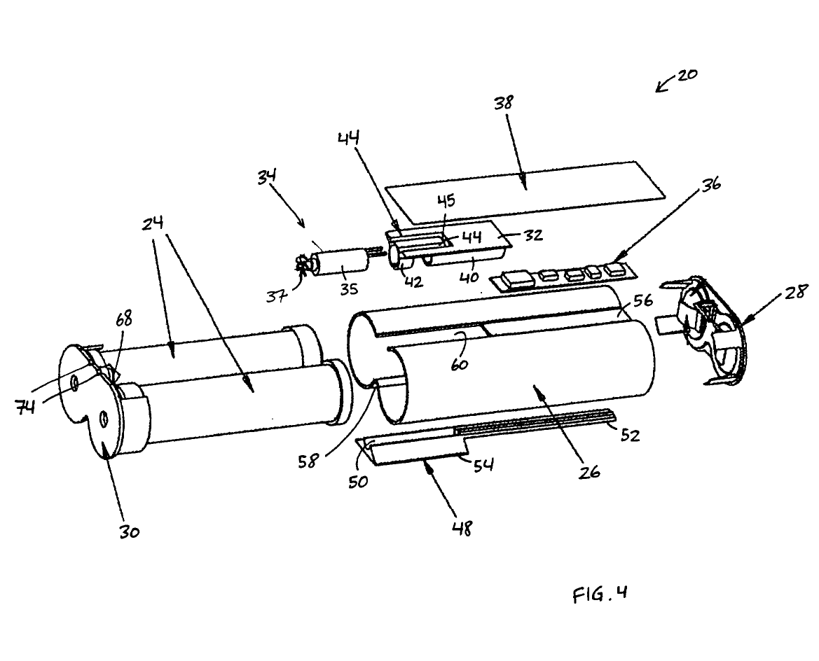

On the sides of housing 26, cartridge 22 includes features for directing air flow through the housing to contact cells 24. On a first side of housing 26, cartridge 22 includes a plate assembly 32, an air mover 34, including, for example, a DC motor 35 available from Kot'l JinLong Machinery, Wenzhou, China PR, an impeller 37, a control circuit 36, and a plate 38 (e.g., a thin member or label made of a plastic such as Mylar®). Plate assembly 32 is configured to engage with cutaway portion 60. Plate assembly 32 includes a first cylindrical portion 40 that receives air mover 34, a second cylindrical portion 42 spaced from the first cylindrical portion, and two grooves 44 (FIGS. 1 and 4). Grooves 44 extend from an end of second cylindrical portion 42 to first cylindrical portion 40, and are in fluid communication with the spacing between portions 40 and 42 through an opening 45 in cylindrical portion 40. When plate 38 covers plate assembly 32 (FIG. 3), the plate and grooves 44 form two air inlet channels 46 in fluid communication with the interior of housing 26 via opening 45 and first cylindrical portion 40.

In other embodiments, air mover 34 can be a diaphragm pump and its variations, or a peristaltic pump. Examples of pumps are described in U.S. Pat. No. 6,274,261; WO 00/36696; WO 01/97317; WO 01/97318; WO 01/97319; and WO 02/31906, all of which are hereby incorporated by reference in their entirety.

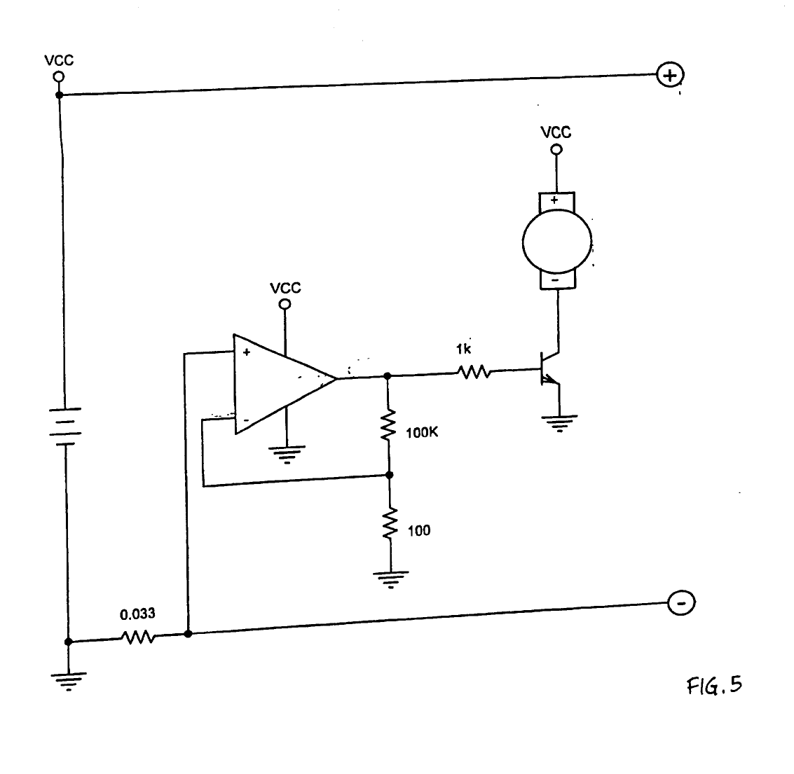

Control circuit 36 is configured to control air mover 34 according to a preselected mode of operation. For example, in some embodiments, control circuit 36 can be designed to activate air mover 34 when the control circuit detects a certain voltage or current, e.g., a threshold current of about 30 milliamps. When the detected voltage or current changes, e.g., in the opposite direction, beyond a certain value, e.g., the threshold current, control circuit 36 can deactivate air mover 34. An example of control circuit 36 is shown schematically in FIG. 5.

On a second side of housing 26 opposite the first side, cartridge 22 includes a cavity key 48 that defines a groove 50 on one surface. As shown, cavity key 48 extends the entire length of housing 26, although in other embodiments, the cavity key can extend only a portion of the length of the housing. Cavity key 48 includes a relatively narrow portion 52 and a relatively wide portion 54. When cavity key 48 is nested within nook 58 (e.g., by gluing), the cavity key and housing 26 define an air outlet channel 64 in which narrow portion 52 is adjacent to cutaway portion 62. The cross sectional area of channel 64 along wide portion 54 is greater than the cross sectional area of the channel along narrow portion 52.

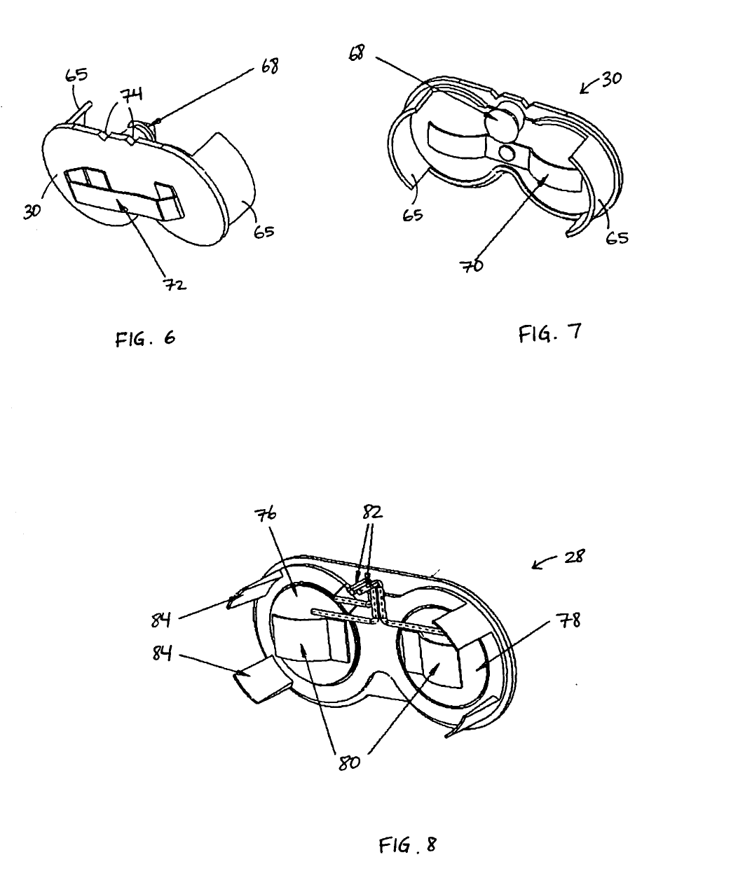

At the ends of housing 26, cartridge 22 includes a contact end assembly 28 attached to the housing and an end cap 30 removably attached to the housing. Referring to FIGS. 6 and 7, end cap 30 is configured to engage with cells 24 and an end of housing 26. End cap 30 includes a lock pin 68, a spring contact 70, and a pull tab 72. Lock pin 68 is a resilient member configured to engage with cylindrical portion 42 of plate assembly 32. Lock pin 68 has a cone-shaped or mushroom-shaped tip portion that, when end cap 30 is fully engaged with housing 26, extends past cylindrical portion 42 and secures the end cap to the housing (FIG. 9). Lock pin 68 can be made, for example, of a deformable urethane or a latex material. Spring contact 70 is attached to the interior surface of end cap 30 and contacts the terminals of cells 24 to electrically connect the cells in series. Pull tab 72, e.g., a piece of fabric attached to the exterior surface of end cap 30, is used to remove end cap 30 from housing 26, e.g., to replace the cells. End cap 30 further includes tangs (here, two) 65 and two notches 74. Tangs 65 position cells 24 within housing 26 such that there is a spacing or plenum between the exterior surface of the cells and the interior surface of the housing. Notches 74 align with grooves 44 of plate assembly 32 to define air inlets to housing 26. Other mechanisms for attaching end cap 30 are possible. For example, end cap 30 can be hingeably attached to cartridge 22. End cap 30 can be permanently attached to, e.g., integrally formed with, cells 24.

Referring to FIG. 8, contact end assembly 28 includes a negative contact 76, a positive contact 78, and spring contacts 80 that contact the terminals of cells 24. Negative contact 76 includes an integral shunt resistor for current sensing (FIG. 5). Negative contact 76 and positive contact 78 are connected to shunt and control leads 82 that connect to control circuit 36 (FIG. 5). Contact end assembly 28 further includes alignment tangs 84 (here, four) that position cells 24 within housing 26 to define a plenum between the exterior surface of the cells and the interior surface of the housing.

In one mode of operation, air is supplied to cells 24 when system 20, specifically, control circuit 36, detects a predetermined threshold current demand from the device in which the system is used. When control circuit 36 detects the threshold current, the circuit activates air mover 34. Referring to FIG. 9, as a result, air is drawn through the air inlets and inlet channels 46, through opening 45, through impeller 37, and through the spacing between cylindrical portions 40 and 42, where the air contacts the exterior surface of cells 24 (see black arrows in FIG. 9). The air first contacts portions of cells 24 between the ends of the cells. Blown by the force of air mover 34 (motor 35 and impeller 37), air flows along the length of cells 24 at a rate sufficient for the oxygen in the air to be used for the electrochemical reactions of the cells to meet the power requirements of the device. Air then flows to contact end assembly 28 and reverses in direction. Air flows through cutaway portion 62, through the relatively narrow portion of outlet channel 64, through the relatively wide portion of the outlet channel, and out the air outlet. Other threshold currents or sensing mechanisms can be use to activate air mover 34. The threshold current can be dependent, for example, on the size of the plenum between cells 24 and housing 26, the rate of discharge, and/or the size of inlet and outlet channels 46 and 64.

In other embodiments, impeller 37 can be configured to rotate such that air can be drawn into or sucked from an exterior of cartridge 22, through outlet channel 64, and blown out of inlet channel 46, i.e., air flow is reversed from the air flow described above. Variable fan speed, e.g., for variable current requirements, can be used. For example, control circuit 36 may include an analog transistor rather than a switching transistor.

When control circuit 36 detects a current below the threshold value, e.g., when the device is turned off, the control circuit deactivates air mover 34. As a result, air mover 34 stops urging air through system 20, and air flow past cells 24 is reduced (e.g., relative to when the air mover is activated), thereby reducing possible carbonation and moisture transpiration, and extending the life of the cells.

Cells 24 and a method of manufacturing the cells will now be described.

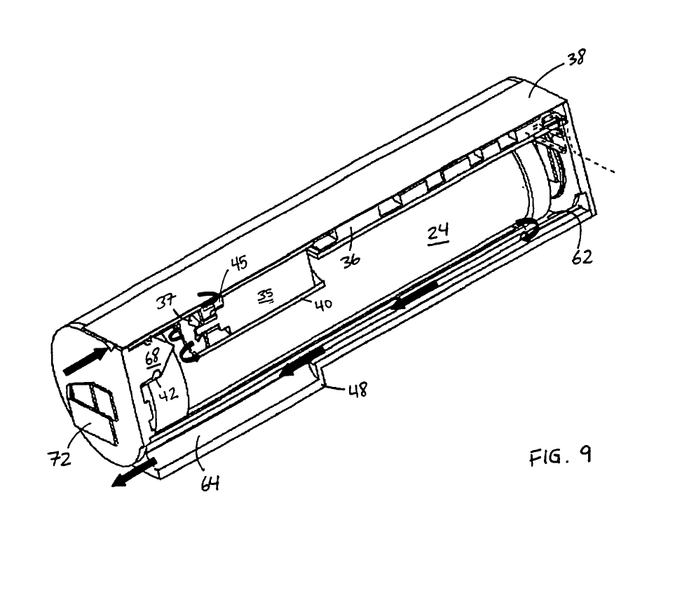

Cells 24 are cylindrical metal-air electrochemical cells configured to be placed inside housing 26. Referring to FIGS. 10-13, cell 24 includes a cathode assembly 100, a cathode seal 102 connected to one end of the cathode assembly, and an anode seal 104 connected to the other end of the cathode assembly. Cathode assembly 100 includes a cathode 106 formed on a current collector 108. Only the exposed portion of current collector 108 is shown. Other portions of current collector 108 are surrounded by cathode material. A separator (not shown) is attached, e.g., glued, to an interior side of the cathode. An air membrane (not shown), an optional blotter or air diffusion layer 110 and a spacer layer 112 are wrapped around an exterior side of cathode 106. Cathode assembly 100 is formed to define a cavity 114 in which an anode material 115 is placed. When cell 24 is fully assembled, spacer layer 112 defines an exterior surface of the cell. In some embodiments, the thickness of spacer layer 112 defines a minimum plenum of cell 24. Spacer layer 112 can also be excluded so that the air membrane defines an exterior surface of the cell.

Cathode 106 includes an active cathode mixture formed on at least a portion of current collector 108. The cathode mixture includes a blend of a catalyst, such as a manganese compound, carbon particles, and a binder. Useful catalysts include manganese oxides, such as Mn₂O₃, Mn₃O₄, MnO₂, and combinations thereof, that can be prepared, for example, by admixing, heating manganese nitrate or by reducing potassium permanganate. Cathode 106 may include between about 1% and about 20%, such as between about 3% and about 5% of catalyst by weight.

The carbon particles are not limited to any particular type of carbon. Examples of carbon include Black Pearls 2000 and Vulcan XC-72 (Cabot Corp., Billerica, Mass.), Shawinigan Black (Chevron, San Francisco, Calif.), Printex (Degussa A G, Frankfurt, Germany), Ketjen Black (Akzo Nobel, Chicago, Ill.), and Calgon PWA (Calgon Carbon, Pittsburgh, Pa.). The cathode mixture may include between about 30% and about 70%, such as between about 50% and about 60%, of total carbon by weight.

Examples of binders include polyethylene powders, polyacrylamides, Portland cement and fluorocarbon resins, such as polyvinylidene fluoride and polytetrafluoroethylene. An example of a polyethylene binder is sold under the tradename Coathylene HA-1681 (Hoechst). A preferred binder includes polytetrafluoroethylene (PTFE) particles, e.g., T-30 (DuPont). The cathode mixture may include between about 10% and 40%, such as between about 30% and about 40%, of binder by weight. The cathode mixture can be formed by blending the catalyst, carbon particles and binder. In other embodiments, gas diffusion electrodes, such as those available from Alupower, Inc. or ETEK, can be used.

The blended cathode mixture is applied to cathode current collector 108, such as a grid mesh, parallelogram metal, or expanded metal mesh screen formed into a cylinder, to form cathode 106. Methods of making a cathode may include, for example, injection molding or extrusion, and are described in commonly-assigned U.S. Ser. No. 09/416,799, filed Oct. 13, 1999, hereby incorporated by reference in its entirety.

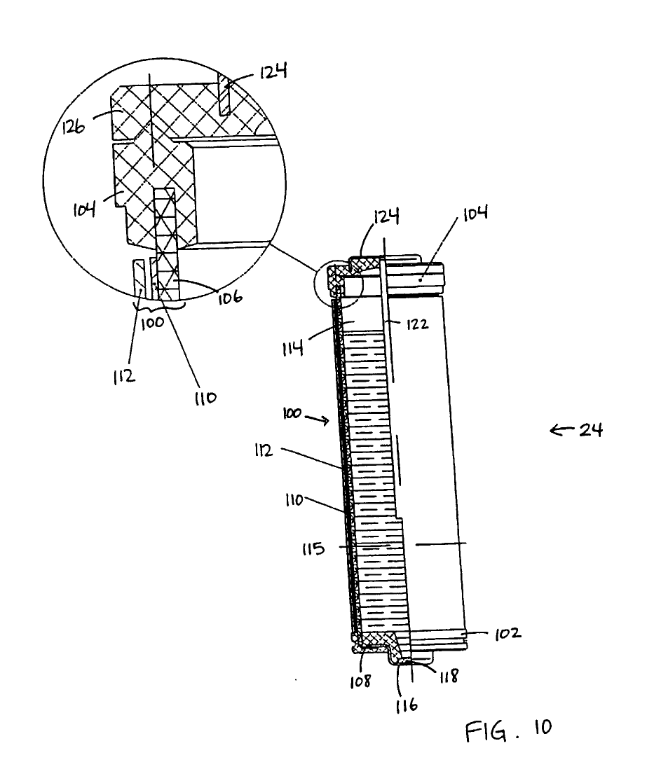

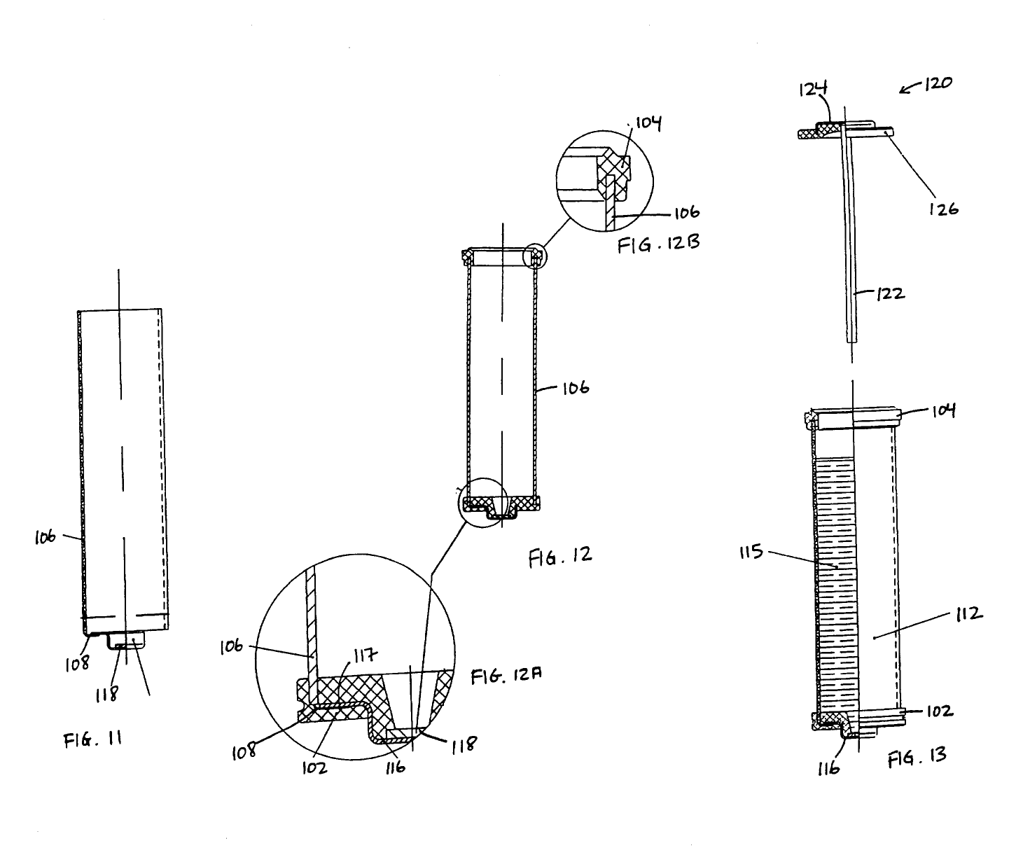

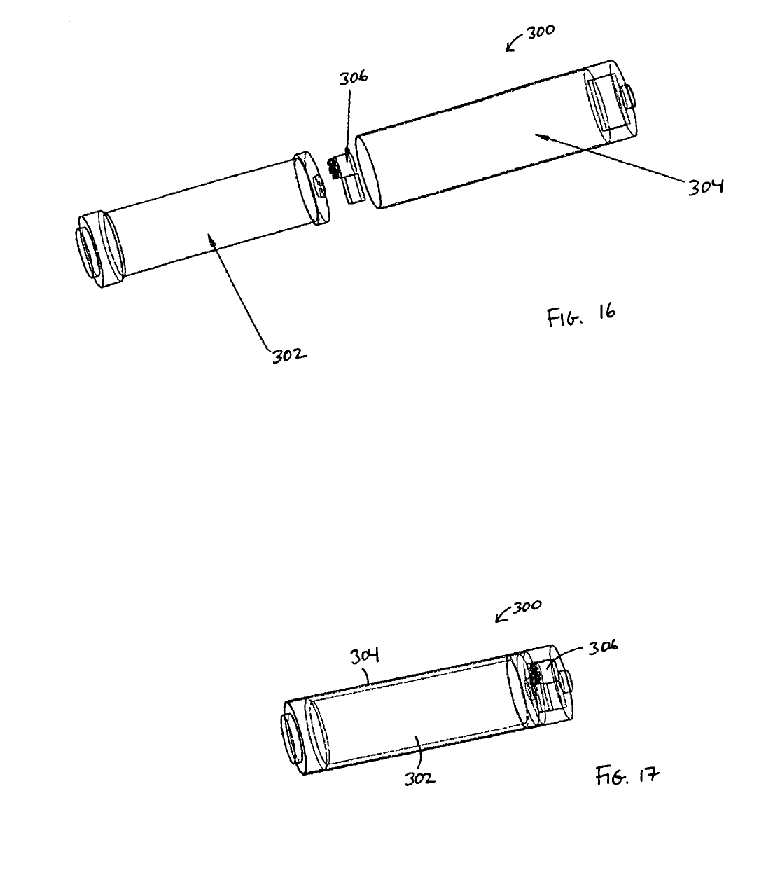

Current collector 108 is then attached (e.g., welded) to a cathode terminal cup 116, which forms the pip of cell 24 (FIG. 11). As shown in FIGS. 12A and 15B, cathode terminal cup 116 includes an extended portion or arm 117 that is attached to an exposed portion of current collector 108. In some embodiments, cathode terminal cup 116 includes more than one, e.g., two, three, four or more, extended portions 117 that are attached to current collector 108. The multiple extended portions 117 can be equally spaced apart to help center cathode terminal cup 116 with the longitudinal axis of cell 24. Attaching multiple extended portions 117 of cathode terminal cup 116 to current collector 108 can also provide a rigid and stable attachment. In other embodiments, current collector 108 (e.g., a mesh) can be integrally formed, e.g., by metal casting, with cathode terminal cup 116 having one or more extended portions 117. A current collector and cathode terminal cup assembly can be placed into a mold or cavity, and a blended cathode mixture can be injected into the mold or cavity to form cathode 106.

On the interior side of cathode 106, a separator is attached (e.g., glued) to the cathode. The separator can be a porous, electrically insulating polymer, such as polypropylene, that allows electrolyte (described below) to contact cathode 106. In some embodiments, the separator can be applied from solution and be formed on cathode 106 when the solution dries, as described in commonly-assigned U.S. Ser. No. 09/568,819, filed May 10, 2000, hereby incorporated by reference in its entirety.

In some embodiments, the air membrane is attached to the exterior side of cathode 106 by pressure, heat, and/or an adhesive. The membrane can be a porous, electrically insulating polymer, such as polytetrafluoroethylene (PTFE), that allows air to permeate from the exterior side of the cell to active sites for oxygen reduction. The membrane can also prevent liquid water from the electrolyte from passing to the exterior of the cell.

Cathode 106 (attached to cathode terminal 116) and the separator are then placed into an insert mold cavity. An insulating disk 118, e.g., a sheet of Mylar® with an adhesive, is placed on the interior side of cathode terminal 116, and electronically separates cathode terminal 116 from anode material 115 in cavity 114. Cathode seal 102 and anode seal 104 are then formed, for example, by conventional insert molding techniques (e.g., using a Nissei NC-9000 G 11 System), such that cathode 106 is securely attached between the seals (FIGS. 12A and 12B). Seals 102 and 104 can be made of materials that are electrically-insulating, relatively resistant to an alkaline electrolyte (such as KOH), and/or relatively high melting (e.g., about 320° C.). Examples of materials for seals 102 and 104 include acrylonitrile-butadiene-styrene (ABS), polysulfones, nylons, polyethylene, and polypropylene. Cathode seal 102 surrounds the exposed portion of current collector 108, portions of cathode terminal 116, and portions of the cathode body. Cathode seal 102 becomes an integral part of cathode 106, and insulates terminal 116 from contact with anode material 115.

Cavity 114 is then filled with anode material 115. Anode material 115 contains a mixture of zinc and electrolyte. The mixture of zinc and electrolyte can include a gelling agent that can help retain moisture within the cell, prevent leakage of the electrolyte from the cell, and/or suspend the particles of zinc within the anode.

The zinc material can be a zinc powder that is alloyed with lead, indium, aluminum, or bismuth. For example, the zinc can be alloyed with between about 400 and 600 ppm (e.g., 500 ppm) of lead, between 400 and 600 ppm (e.g., 500 ppm) of indium, or between about 50 and 90 ppm (e.g., 70 ppm) aluminum. Preferably, the zinc material can include indium, aluminum, and/or bismuth. The zinc material can be air blown or spun zinc. Suitable zinc particles are described, for example, in U.S. Ser. No. 09/156,915, filed Sep. 18, 1998, U.S. Ser. No. 08/905,254, filed Aug. 1, 1997, and U.S. Ser. No. 09/115,867, filed Jul. 15, 1998, each of which is incorporated by reference in its entirety.

The particles of the zinc can be spherical or nonspherical. For example, the zinc particles can be acicular in shape (having an aspect ratio of at least two). The zinc material includes a majority of particles having sizes between 60 mesh and 325 mesh. For example, the zinc material can have the following particle size distribution:

0-3 wt % on 60 mesh screen;

40-60 on 100 mesh screen;

30-50 wt % on 200 mesh screen;

0-3 wt % on 325 mesh screen; and

0-0.5 wt % on pan.

Suitable zinc materials include zinc available from Union Miniere (Overpelt, Belgium), Duracell (USA), Noranda (Canada), Grillo (Germany), or Toho Zinc (Japan).

The gelling agent is an absorbent polyacrylate. The absorbent polyacrylate has an absorbency envelope of less than about 30 grams of saline per gram of gelling agent, measured as described in U.S. Pat. No. 4,541,871, incorporated herein by reference. The anode gel includes less than 1 percent of the gelling agent by dry weight of zinc in the anode mixture. Preferably the gelling agent content is between about 0.2 and 0.8 percent by weight, more preferably between about 0.3 and 0.6 percent by weight, and most preferably about 0.33 percent by weight. The absorbent polyacrylate can be a sodium polyacrylate made by suspension polymerization. Suitable sodium polyacrylates have an average particle size between about 105 and 180 microns and a pH of about 7.5. Suitable gelling agents are described, for example, in U.S. Pat. No. 4,541,871, U.S. Pat. No. 4,590,227, or U.S. Pat. No. 4,507,438.

In certain embodiments, the anode material can include a non-ionic surfactant. The surfactant can be a non-ionic phosphate surfactant, such as a non-ionic alkyl phosphate or a non-ionic aryl phosphate (e.g., RA600 or RM510, available from Rohm & Haas), which may be coated on the zinc surface. The anode material can include between about 20 and 100 ppm of the surfactant coated onto the surface of the zinc material. The surfactant can serve as a gassing inhibitor.

The electrolyte can be an aqueous solution of potassium hydroxide. The electrolyte can include between about 30 and 40 percent by weight, such as between 35 and 40 percent of potassium hydroxide. The electrolyte can also include between about 1 and 2 percent of zinc oxide.

Referring to FIG. 13, cell 24 is then sealed using an anode current collector assembly 120. Assembly 120 includes an anode current collector 122 (e.g., a tin-plated brass rod or nail) attached (e.g., welded) to an anode cap 124 that forms an anode terminal. Current collector 122 and anode cap 124 (e.g., made from nickel plated 1110 cold-rolled steel) are attached to an electronically insulating seal member 126 (e.g., made of ABS). Seal member 126 can be attached to collector 122 and cap 124, e.g., by over insert molding. Anode current collector assembly 120 can be attached to anode seal 104 by ultrasonic welding to seal cell 24.

Blotter layer 110 is then wrapped around the exterior side of cathode 106. Blotter layer 110 is used to distribute air and/or to absorb material, e.g., electrolyte that may leak through cathode 106. Blotter layer 110 can be a woven or nonwoven material that is air-permeable, absorbent, and/or stable to the electrolyte, such as KOH. Blotter layer 110 can be, for example, Whatman paper, or Pelon (e.g., P3, P5, P12, or P28, nonwoven, uncalendered polyamides fabrics available from Freudenberg Nonwovens Technical Products Division, Lowell, Mass.).

In some embodiments, blotter layer 110 includes a material, such as potassium hydroxide, capable of reacting with carbon dioxide to reduce the occurrence of carbonation of the electrolyte. Carbonation of electrolyte can reduce the amount of electrolyte available to cell 24. Carbonation can also increase leakage of electrolyte from cell 24 by forming potassium carbonate, which can increase the porosity of the air membrane and allow the electrolyte to leak through the membrane. In some embodiments, a paste of KOH can be applied to blotter layer 110 and dried. Since blotter layer 110 is placed on the exterior of cathode 106, the KOH on the blotter layer can react with carbon dioxide before the carbon dioxide can react with electrolyte in the cathode. As a result, the amount of carbon dioxide that can react with electrolyte in the cathode and leakage of electrolyte can be reduced. The paste of KOH can be applied to blotter layer 110 in a pattern, such as grid or a series of stripes.

Spacer layer 112 is then wrapped around blotter layer 110. Spacer layer 112 can be a non-conductive (e.g., a polymer such as polypropylene, polyethylene, nylon, polyurethane, or silicone rubber) mesh sleeve or grid that protects the exterior surface of cell 24. The sleeve or grid can be relatively flexible and resilient, e.g., like an elastic band, to help keep blotter layer 110 in close contact with cathode 106. The mesh can have openings that are, e.g., about one-eighth inch in width or diameter. Blotter layer 110 and spacer layer 112 can be glued to each other.

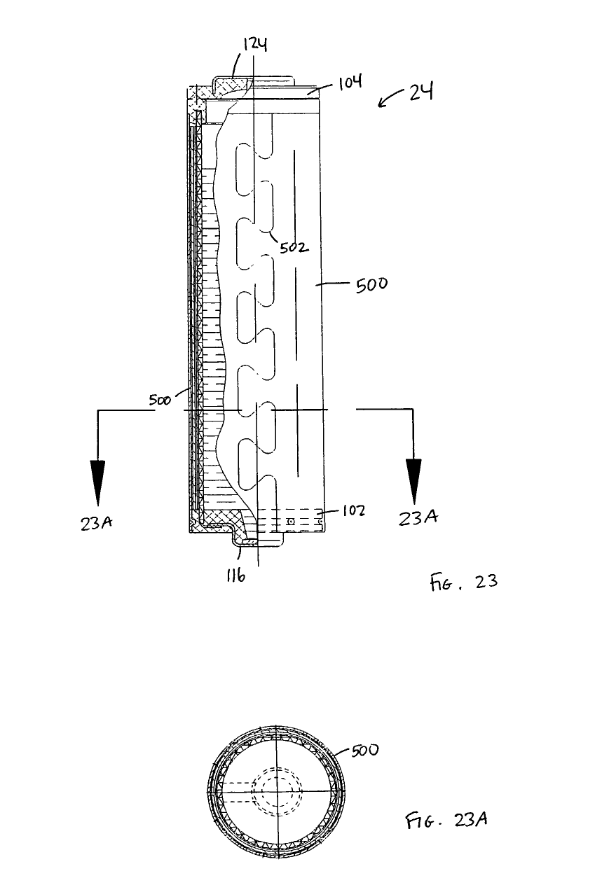

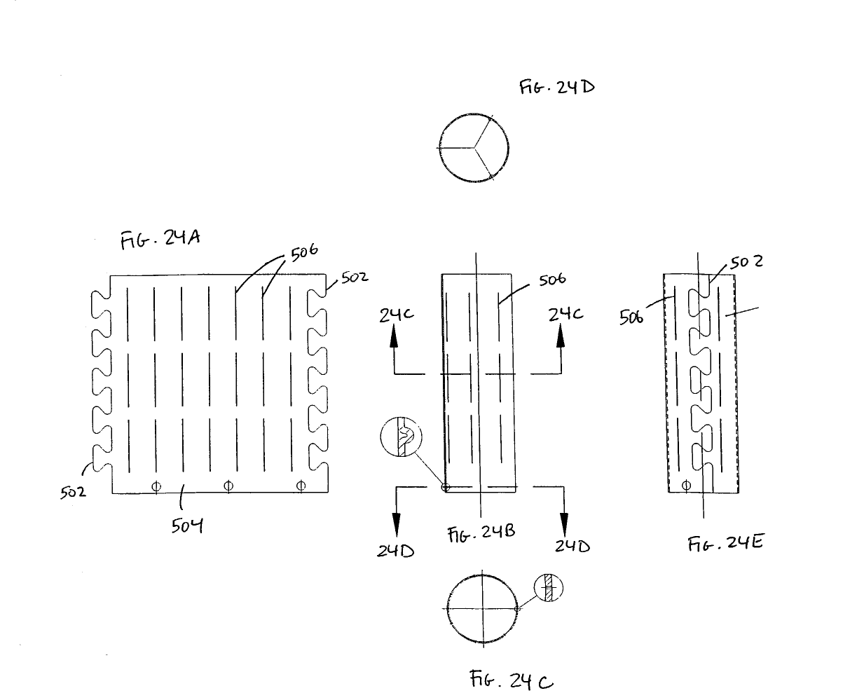

In some embodiments, cell 24 can include a can or outer housing, e.g., a cylindrical metal, plastic, or rubber housing. The outer housing or shroud may contain one or more air access ports. Blotter layer 110 and/or spacer layer 112 can help to define an air plenum between the interior surface of the can and the exterior surface of cathode 106. For example, referring to FIGS. 23 and 23A, cell 24 can include an outer layer 500 having interlocking opposing edges 502. As shown, edges 502 have pins and tails that mate with each other and lock to hold layer 500 into a generally cylindrical shape. Referring to FIGS. 24A-24E, outer layer 500 can be formed by cutting, e.g., laser cutting, a flat blank 504 of material such as a metal or a plastic (FIG. 24A). Blank 504 can also be cut to include slits 506, louvers, and/or air access openings. The formed blank can then be wrapped around a mandrel to bring and lock edges 502 together. Other configurations for edges 502 are possible. For example, edges 502 can be formed to include arrowhead shaped configurations, T-shaped configurations, or any other configurations that allow the edges to lock together.

In other embodiments, blotter layer 110 and/or spacer layer 112 can be complemented with or replaced by an air-permeable and liquid-impermeable barrier layer, e.g., a PTFE (available from Saint-Gobain Performance Plastics) or Mylar® membrane, that helps to maintain a consistent humidity level in cell 24. The barrier layer can also help to restrict the electrolyte from leaking out of cell 24 and CO₂ from entering into the cell, and reduce physical damage to the cell. In some embodiments, the can may include louvers, as described in U.S. Pat. No. 6,232,007, hereby incorporated by reference in its entirety.

During storage, cell 24 can be covered with a removable sheet, for example, an oxygen semi-impermeable and hydrogen permeable sheet, that restricts the flow of air between the interior and exterior of the cell. A user can peel the sheet from cell 24 prior to placing the cell into housing 26 to allow oxygen to enter the interior of the cell. Cell 24 can also be stored in a sealed metal bag, and the user can remove the cell from the bag before use.

Cell 104 can be formed in numerous sizes, such as, for example, AA, AAA, AAAA, C, or D. In other embodiments, depending, for example, on the configuration of the housing and/or the battery compartment of the device, cell 24 can have a non-circular cross section, such as oval, elliptical, or polygonal, e.g., having 3, 4, 5, 6, 7, or 8 or more sides. The cross section can be irregular or regular.

### Other Embodiments

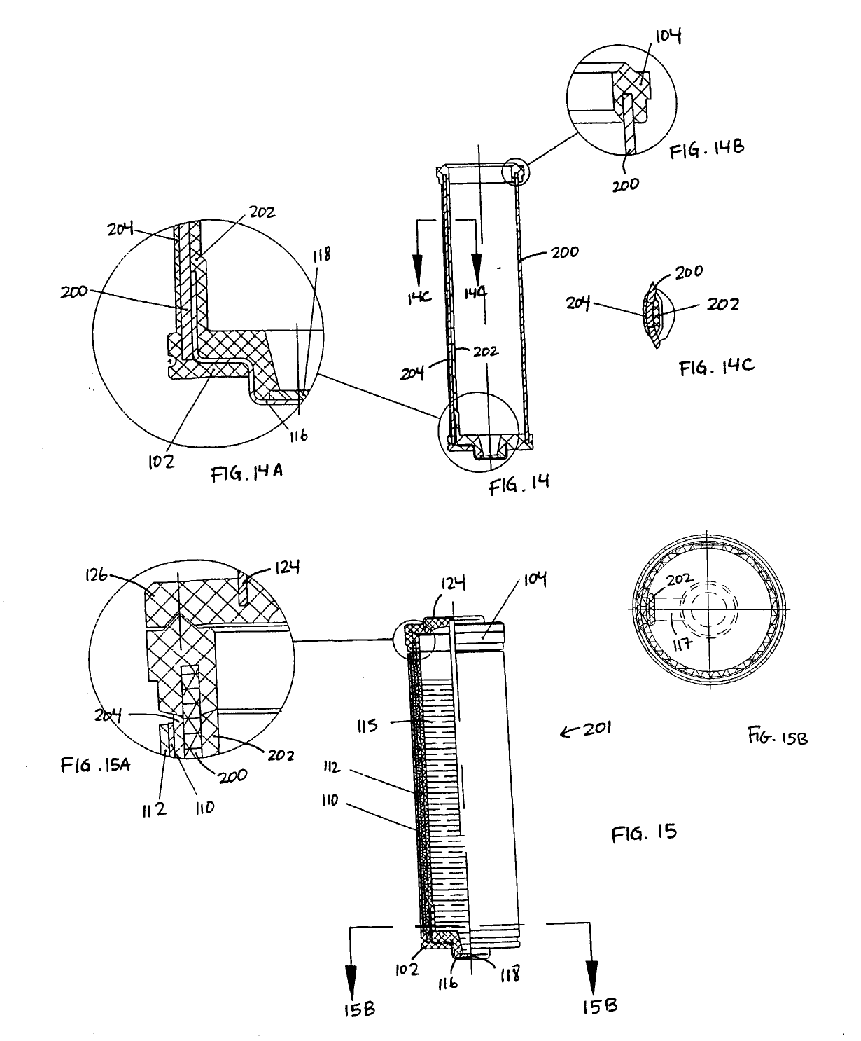

In other embodiments, cell 201 includes a seamed cathode. Referring to FIGS. 14-15, in which features similar to the features described above are designated with the same reference numbers, a seamed cathode 200 is formed by applying the cathode mixture to current collector 108 but leaving section of the current collector exposed (e.g., by masking), i.e., not coated with the cathode mixture. The exposed section can correspond to opposing edge portions of a cylinder that is formed from a flat sheet. To define cavity 114, cathode 200 is wrapped (e.g., around a mandrel), and the exposed edge portions of current collector 108 are joined together (e.g., by welding), which forms a seam (not shown) extending along the length of cathode 200. During formation of cathode seal 102 and anode seal 104, e.g., by insert molding, the seam is covered or sealed by forming an internal seam 202 and an external seam 204. Seams 202 and 204 can be polymeric (e.g., ABS) or rubber strips that are formed with seals 102 and 104 by insert molding. Cell 201 can be completed as described above for cell 24. A seamless cathode can provide more active area (e.g., exposed portions) than a seamed cathode, e.g., one having seams 202 and 204.

In some embodiments, system 20 can accommodate one cell or more than two cells, e.g., four, six, or eight or more. FIGS. 16 and 17 shows a cell system 300 having one cell 302 and a cartridge 304 configured to receive the cell. Cell 302 is generally as described above. Cartridge 304 includes an air mover 306, as generally described above, located at one end of the cartridge. During use, air is drawn into one end of cartridge 304 (e.g., through an inlet, not shown), blown through the annular plenum defined between cell 302 and the cartridge, and out through the other end of the cartridge (e.g., through an outlet, not shown).

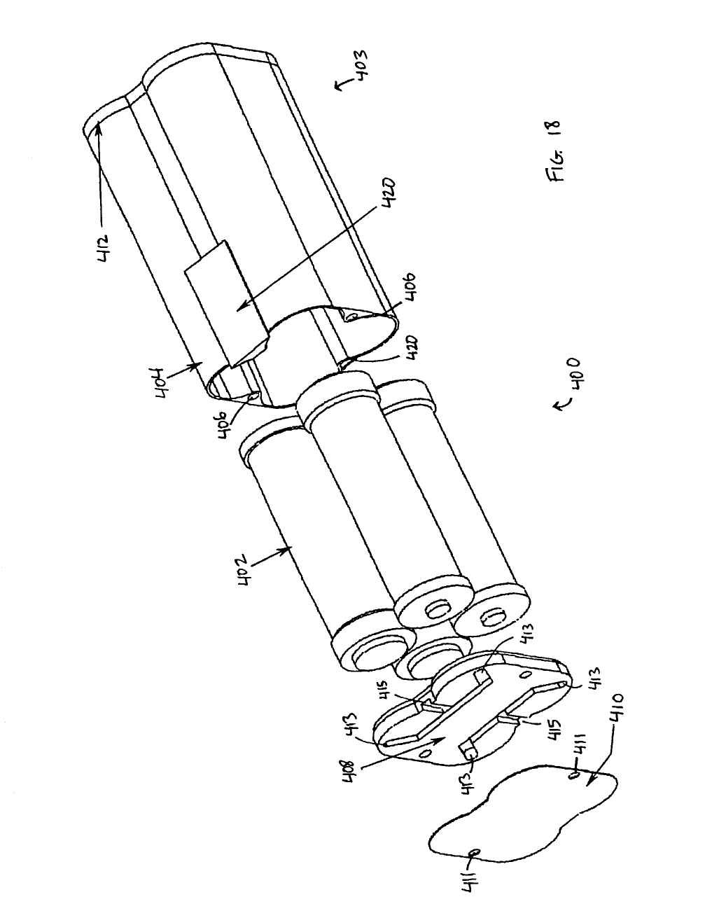

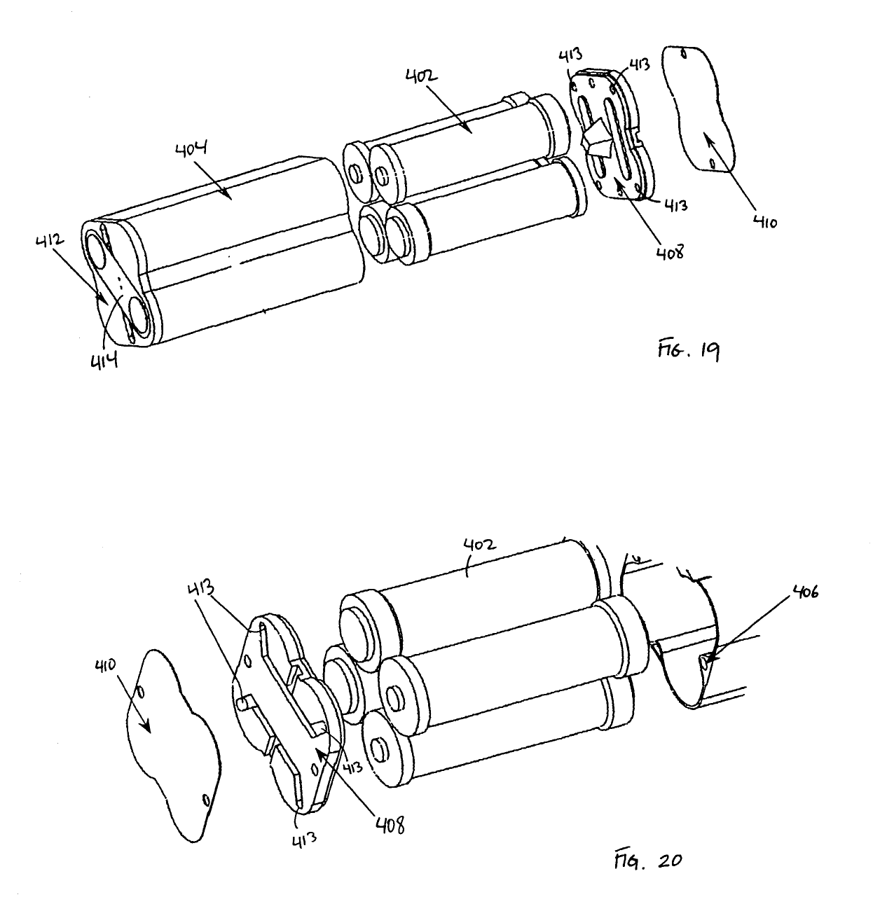

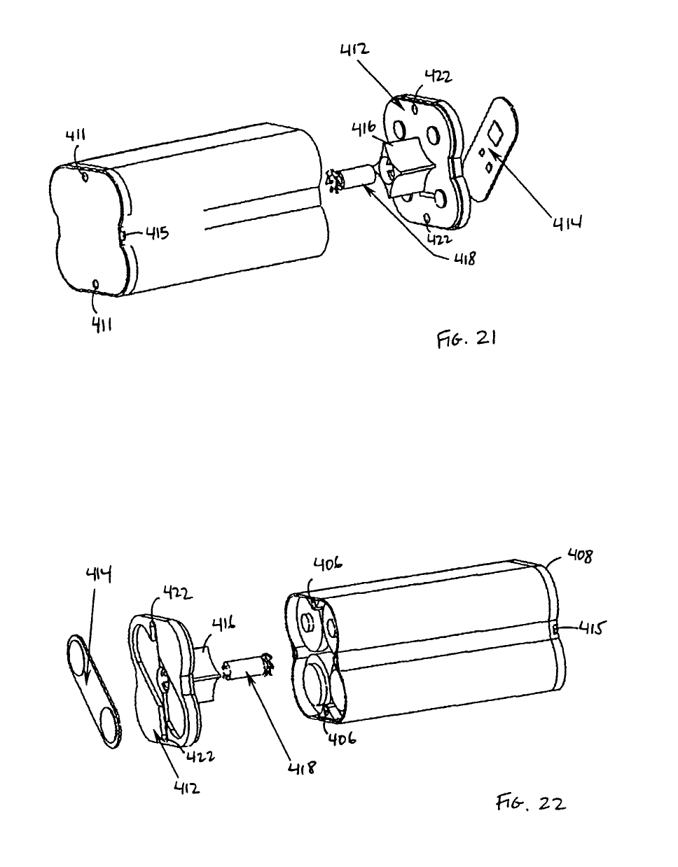

FIGS. 18-22 show a cell system 400 having four cells 402 and a cartridge 403. Cartridge 403 includes a housing 404 configured to receive cells 402 and having two integrally-formed inlet channels 406. As shown, cartridge 403 further includes two assemblies 420 generally including a plate assembly, an air mover, a control circuit, and a plate, as described above. At one end, cartridge 403 includes a first end cap 408, which can be removable, and a cover 410. End cap 408 has a plurality (here, four) of openings 413 and two outlets 415 in fluid communication with the openings. Cover 410 has two inlet ports 411. At the other end, cartridge 403 includes a second end cap 412, which can be fixed to the cartridge. Second end cap 412 includes a contact circuit board 414 as generally described above, an air mover housing 416, and an air mover 418 in the air mover housing.

During use, air is drawn by air mover 418 through inlet ports 411 and flows through inlet channels 406 from end cap 408 to end cap 412. Air then flows through openings 422 of end cap 412 and through air mover housing 416. When air exits housing 416, air flows through housing 404 and contacts cells 402. Air then flows through openings 413 of end cap 408, through outlets 415 and out of system 400. In some embodiments, air can flow through assemblies 420, as described above for system 20. In other embodiments, air mover 418 can reverse the air flow through system 400.

In other embodiments, one or more portions of the barrier layer or air membrane are modified relative to other portion(s) of the barrier layer to adjust the rate of flow of materials, such as oxygen, water, and carbon dioxide, through the barrier layer. For example, portion(s) of the barrier layer that are closer to an inlet channel or an outlet channel (i.e., shorter diffusion paths) may have higher transport resistance than other portion(s) of the barrier layer farther from the channel(s) (i.e., longer diffusion paths) to enhance (e.g., maximize) uniform oxygen access and/or to enhance (e.g., minimize) water transport. Portion(s) of the barrier layer can have different mass transport resistance or permeability to selected material(s) than other portion(s) of the barrier layer. Portion(s) of the barrier layer can have different porosity than other portion(s) of the barrier layer. Portion(s) of the barrier layer can have different apparent density than other portion(s) of the barrier layer. In these and other embodiments, one or more portions of the barrier layer are not uniform around the cells.

Numerous methods can be used to modify, e.g., increase or decrease, properties of the barrier layer, such as the mass transport resistance of a material, such as water vapor and/or oxygen, through the layer. In some embodiments, the barrier layer is modified by mechanical work. In other embodiments, the thickness of the barrier layer is modified. Other methods of modifying the barrier layer are described in commonly assigned U.S. Ser. No. 10/060,701, entitled “Batteries and Battery Systems” and filed Jan. 30, 2002, and U.S. Ser. No. ______ [Attorney Docket 08935-263001], entitled “Electrochemical Cells and Systems, filed on the same day as this application, hereby incorporated by reference in its entirety.

The cells can be placed symmetrically or asymmetrically. The cells can be placed end-to-end and/or side-by-side. The cells can be placed in series and/or in parallel within a cartridge.

In other embodiments, other types of electrochemical cells, e.g., air-assisted cells, can be used. Air-assisted cells are described, for example, in U.S. Pat. No. 6,372,370, hereby incorporated by reference in its entirety. Other types of metal-air cells, such as magnesium-air cells or aluminum-air cells, can also be used.

Other methods of making cells are described, for example, in commonly-assigned U.S. Ser. No. 10/060,701, filed Jan. 30, 2002, hereby incorporated by reference in its entirety. Other metal-air cells and methods of making them are described in U.S. Ser. No. 09/374,277, filed Aug. 13, 1999; U.S. Ser. No. 09/374,278, filed Aug. 13, 1999; U.S. Ser. No. 09/416,799, filed Oct. 13, 1999; U.S. Ser. No. 09/427,371, filed Oct. 26, 1999; and U.S. Ser. No. 09/494,586, filed Jan. 31, 2000, all of which are hereby incorporated by reference in their entirety.

The following example is illustrative and not intended to be limiting.

### EXAMPLE

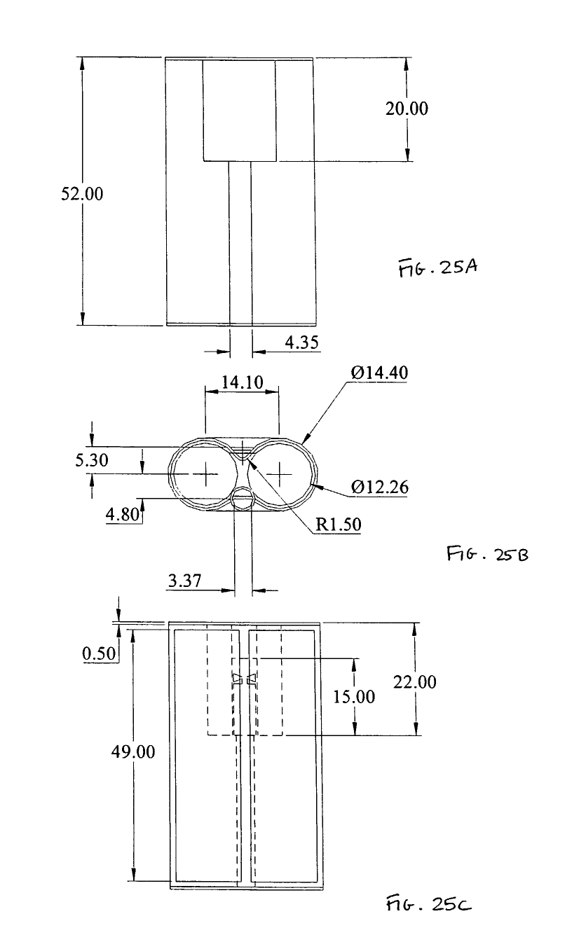

Referring to FIGS. 25A, 25B, and 25C, illustrative dimensions (in mm) of an electrochemical cell system are shown. Based on the configuration shown and standard, median cells, the system has a volume of about 18.6 cc, of which about 1.5 cc (or 8.1%) is occupied by an air management system, which includes the air manager and the control circuit. The available cell volume is 5.8 cc for each cell. Therefore, for a two-cell system, about 62.0% of the cell system is available for the cells. The cell volume is based on a 5.9 Ah seamless cell with a 1.0 mm air plenum between the cells and the cartridge.

Based on an internal cell void volume of 10% (for zinc expansion) and a cell efficiency of 63% with an average operating voltage of 2.2 V, the following performance is projected:

TABLE 1

| | | |
|---|---|---|
| Cathode Area | 13.7 | cm² |
| Active Cathode | 12.3 | cm² |
| Current Density at 1.0 A | 81 | mA/cm² |
| Fill Weight | 10.3 | g |
| Capacity | 5.9 | Ah/cell |
| Energy | 8.2 | Wh |
| Cartridge Volume | 18.6 | cc |
| Energy Density | 440 | Wh/L |

The electrochemical cell system can operate with relatively high efficiency. For example, the system can be operated with at a relatively low air stoichiometric rate factor, such as about 2.5 to about 4, at a flow rate of about 2.5 to 9 L/hr, and an air plenum of about 0.5-1.2 mm, e.g., about 1.0 mm. The flow rate can be achieved using an air mover having a 3.8 mm diameter impeller operating at between 18,000 and 29,000 RPM. The system can also have relatively low flow losses, e.g., having a flow efficiency of 80% or greater based on the stoichiometric amount of air required divided by the minimum air flow the system would operate on at 1 Amp. It is believed that the efficiency of the system is due at least in part to the close proximity of fresh reactant air to the cathode. In some embodiments, the distance between the air mover exit and the cathode is between about two and four millimeters.

All publications and patents mentioned in this application are herein incorporated by reference to the same extent as if each individual publication or patent was specifically and individually indicated to be incorporated by reference.

Other embodiments are within the claims.

What is claimed is:

1. An electrochemical cell system, comprising:
a cartridge comprising an air inlet channel and an air outlet channel, wherein during use air flows through the inlet channel in a substantially opposite direction than air flowing through the outlet channel; and
an air mover in the cartridge configured to move air through the channels.

2. The system of claim 1, wherein the air inlet channel comprises an air inlet, and the air outlet channel comprises an air outlet, the air inlet and outlet being located at the same end of the cartridge.

3. The system of claim 1, wherein the inlet channel and the outlet channel are located on opposing sides of the cartridge.

4. The system of claim 1, wherein the air outlet channel extends substantially an entire length of the cartridge.

5. The system of claim 1, wherein the air outlet channel has a differential cross sectional area along its length.

6. The system of claim 1, wherein the air mover comprises a fan.

7. The system of claim 1, wherein the control circuit activates the air mover at a selected threshold current.

8. The system of claim 1, wherein the cartridge is configured to receive a removable metal-air cell.

9. The system of claim 1, further comprising a metal-air cell in the cartridge.

10. The system of claim 9, wherein the metal-air cell has a first end and a second end, and the air mover is located between the ends of the cell.

11. The system of claim 9, wherein the metal-air cell has a first end and a second end, and air flow does not extend past the ends of the cell.

12. The system of claim 9, wherein the air mover is less than about 4 mm from the cell.

13. The system of claim 9, wherein the air mover is less than about 3 mm from the cell.

14. The system of claim 9, wherein the cell comprises a polymer layer having variable transport resistance along a length of the cell.

15. The system of claim 14, wherein the transport resistance varies as a function of a distance from the air inlet channel.

16. The system of claim 1, wherein air flow does not recirculate in the system.

17. The system of claim 1, further comprising a control circuit in the cartridge configured to control operation of the air mover.

18. The system of claim 9, wherein the metal-air cell comprises a polymeric layer surrounding a portion of the cell, the polymeric layer defining an exterior portion of the cell.

19. The system of claim 18, wherein the polymeric layer comprises a material selected from a group consisting of polypropylene and Mylar®.

20. The system of claim 9, wherein during use, air first contacts the metal-air cell at a portion between the ends of the cell.

21. The system of claim 1, further comprising a plurality of metal-air cells in the cartridge.

22. The system of claim 1, wherein the cartridge is sized to fit into a battery compartment of an electronic device.

23. The system of claim 22, wherein the battery compartment is sized to accommodate a plurality of batteries.

24. The system of claim 1, wherein the cartridge comprises a housing, and during use, air is introduced into the housing between the ends of the housing.

25. The system of claim 1, wherein the cartridge comprises a housing, and a portion of the outlet channel is external to the housing.

26. An electrochemical cell system, comprising:
a cartridge comprising a first end and an opposing second end, the cartridge further comprising an air inlet and an air outlet located at the same end; and
an air mover in the cartridge, the air mover configured to move air from the inlet to the outlet.

27. The system of claim 26, wherein the cartridge is configured to receive a removable metal-air cell.

28. The system of claim 26, wherein the cartridge comprises a channel including the air outlet, the channel extending along substantially an entire length of the cartridge.

29. The system of claim 28, wherein the cartridge comprises a housing, and a portion of the channel is external to the housing.

30. The system of claim 26, wherein the cartridge comprises a housing, and the air inlet and outlet are external to the housing.

31. The system of claim 26, wherein the air mover comprises a motor and an impeller.

32. The system of claim 26, further comprising a control circuit in the cartridge configured to control operation of the air mover.

33. The system of claim 26, further comprising a metal-air cell in the cartridge.

34. The system of claim 33, wherein the cell comprises a polymer layer having variable transport resistance along a length of the cell.

35. The system of claim 34, wherein the transport resistance varies as a function of a distance from the air inlet channel.

36. The system of claim 33, wherein the metal-air cell has a first end and a second end, and the air mover is located between the ends of the cell.

37. The system of claim 33, wherein the metal-air cell has a first end and a second end, and air flow does not extend past the ends of the cell.

38. The system of claim 33, wherein the air mover is less than about 4 mm from the cell.

39. The system of claim 33, wherein the air mover is less than about 3 mm from the cell.

40. The system of claim 26, wherein air flow does not recirculate in the system.

41. The system of claim 26, further comprising a plurality of metal-air cells in the cartridge.

42. The system of claim 26, wherein the cartridge is sized to fit into a battery compartment of an electronic device.

43. The system of claim 42, wherein the battery compartment is sized to accommodate a plurality of batteries.

44. An electrochemical cell system, comprising:
a cartridge having an internal volume; and
two metal-air cells removably placed in the cartridge,
wherein the cells occupy at least 50% of the internal volume of the cartridge.

45. The system of claim 44, wherein the cells occupy at least 60% of the internal volume of the cartridge.

46. An electrochemical cell system, comprising:
a cartridge having an internal volume;
an air mover in the cartridge; and
a control circuit in the cartridge, wherein the air mover and the control circuit occupy less than about 2% of the internal volume of the cartridge.

47. The system of claim 46, wherein the air mover and the control circuit occupy less than about 1.6% of the internal volume of the cartridge.

48. An electrochemical cell system, comprising:
a cartridge; and
two metal-air cells removably placed in the cartridge,
wherein the system has an energy density greater than about 400 Wh/L.

49. The system of claim 48, wherein the system has an energy density greater than about 420 Wh/L.

50. An electrochemical cell system, comprising:
a cartridge; and
two metal-air cells removably placed in the cartridge,
wherein the system has a capacity greater than about 5.4 Ah/cell.

51. The system of claim 50, wherein the system has a capacity greater than about 5.6 Ah/cell.

52. The system of claim 50, wherein the system has a capacity greater than about 5.8 Ah/cell.

53. A metal-air cell, comprising:
an anode;
a polymer layer having openings through the polymer layer;
a separator between the anode and the polymer layer; and
a cathode between the separator and the polymer layer.

54. The cell of claim 53, wherein the polymer layer is a mesh.

55. The cell of claim 53, wherein the polymer layer is a resilient tubular sleeve.

56. The cell of claim 53, further comprising a blotter layer between the cathode and the polymer layer.

57. An electrochemical cell system, comprising:
a housing;
a metal-air cell in the housing, the cell comprising:
an anode,
a polymer layer having openings through the polymer layer,
a separator between the anode and the polymer layer, and
a cathode between the separator and the polymer layer; and
an air mover in the housing.

58. A metal-air cell, comprising:
an anode;
an outer layer having interlocking opposing edges;
a separator between the anode and the outer layer; and
a cathode between the separator and the outer layer.

59. The cell of claim 58, wherein one edge of the outer layer is configured with a dovetail joint.

60. The cell of claim 58, wherein the outer layer comprises a metal.

61. The cell of claim 58, wherein the outer layer comprises a polymer.

62. The cell of claim 58, wherein the outer layer comprises an air access opening.

63. The cell of claim 58, wherein the outer layer comprises a slit.

64. The cell of claim 58, further comprising a blotter layer between the outer layer and the cathode.

65. The cell of claim 58, further comprising a polymer layer between the outer layer and the cathode.

66. An electrochemical cell system, comprising:
a housing;
a metal-air cell in the housing, the cell comprising:
an anode,
an outer layer having interlocking opposing edges,
a separator between the anode and the outer layer, and
a cathode between the separator and the outer layer; and
an air mover in the housing.

67. A metal-air cell, comprising:
a cathode current collector; and
a cathode terminal having an integral portion extending radially from the terminal, the integral portion being attached to the cathode current collector.

68. The cell of claim 67, wherein the cathode terminal comprises a plurality of discrete, integral portions extending radially from the terminal, the plurality of integral portions being attached to the cathode current collector.

69. The cell of claim 67, wherein the plurality of integral portions are equally spaced about the cathode terminal.

70. The cell of claim 67, wherein the current collector is welded to the integral portion.

71. The cell of claim 67, further comprising a polymer seal surrounding a portion of the cathode terminal.

72. An electrochemical cell system, comprising:
a housing;
a metal-air cell in the housing, the cell comprising:
a cathode current collector, and
a cathode terminal having an integral portion extending radially from the terminal, the integral portion being attached to the cathode current collector; and
an air mover in the housing.

73. A method of operating an electrochemical cell system, the method comprising:
introducing air through an air inlet channel of a cartridge in a first direction; and
introducing air through an air outlet channel of the cartridge in a second direction opposite to the first direction,
wherein air is introduced through the channels by an air mover in the cartridge.

74. The method of claim 73, further comprising contacting a metal-air cell in the cartridge with air at a portion between the ends of the cell.

75. The method of claim 74, further comprising replacing the metal-air cell with a second metal-air cell.

76. The method of claim 73, further comprising activating the air mover according to a preselected threshold current.

77. A method of operating an electrochemical cell system, the method comprising:
providing a cartridge comprising an air inlet and an air outlet located at one end of the cartridge;
introducing air into the air inlet; and
flowing air through the air outlet and out the cartridge,
wherein air is introduced through the air inlet by an air mover in the cartridge.

78. The method of claim 77, further comprising contacting a metal-air cell in the cartridge with air at a portion between the ends of the cell.

79. The method of claim 78, further comprising replacing the metal-air cell with a second metal-air cell.
